(19) United States
(12) Patent Application Publication
(10) Pub. No.: US 2015/0029567 A1
(43) Pub. Date: Jan. 29, 2015

(54) FOLDING HOLOGRAPHIC SIGHT FOR A GUN

(71) Applicant: OptiFlow, Inc., Ann Arbor, MI (US)

(72) Inventors: Fred Collin, Brighton, MI (US); Kurt Douglas Mills, Stockbridge, MI (US); David S. Dilworth, Ann Arbor, MI (US); Rod Collin, Saline, MI (US); Stephen Michael Shubeck, Ann Arbor, MI (US); Christopher Stephen Hyde, Clarkston, MI (US)

(21) Appl. No.: 14/482,080

(22) Filed: Sep. 10, 2014

Related U.S. Application Data
(63) Continuation-in-part of application No. 14/331,925, filed on Jul. 15, 2014.
(60) Provisional application No. 62/005,262, filed on May 30, 2014.
(60) Provisional application No. 61/883,532, filed on Sep. 27, 2013.
(60) Provisional application No. 61/879,393, filed on Sep. 18, 2013.
(60) Provisional application No. 61/846,251, filed on Jul. 15, 2013.
(60) Provisional application No. 61/877,066, filed on Sep. 12, 2013.

(51) Int. Cl. G02B 27/01; G03H 1/02; G03H 1/00

(52) U.S. Cl. CPC G02B 27/0149; G02B 27/0189; G02B 27/0103; G03H 1/0005; G03H 1/02; G02B 2027/015; G03H 2001/0212; G03H 2001/0232
USPC 359/13

(57) ABSTRACT

A holographic weapon sight folds for storage or to position where a portion of the sight is out of the way when not in use. Certain embodiments include a readout beam source mounted to the stationary base of the sight and the source directly illuminates a hologram plate supported in a pivotally mounted hologram support when the sight is in a position intended for use.

### CROSS-REFERENCE TO RELATED APPLICATIONS

This utility patent application claims priority from U.S. provisional patent application Ser. No. 61/877,066, filed Sep. 12, 2013, the entire content of which is incorporated herein in its entirety and is a Continuation-in-Part application of U.S. patent application Ser. No. 14/331,925.

### FIELD OF THE INVENTION

The present invention relates generally to gun sights. Specifically, the present invention relates to a holographic gun sight operable to fold for storage.

### BACKGROUND OF THE INVENTION

Holographic weapon sights are popular but their size and configuration makes them inconvenient to use on some weapons. For example, a typical holographic weapon sight mounted on a handgun makes the handgun too large for the holster. Likewise, a holographic weapon sight on a rifle may interfere with storage in a case.

### SUMMARY OF THE INVENTION

The present invention provides a holographic gun sight that folds for storage or to a position where a portion of the sight is out of the way when not in use. Certain embodiments include a readout beam source mounted to the stationary base of the sight and the source directly illuminates a hologram plate supported in a pivotally mounted hologram support when the sight is in a position intended for use. The gun sight is for use with a hand held gun or similar weapon.

### BRIEF DESCRIPTION OF THE DRAWINGS

FIG. 1 is a perspective view of an embodiment of a folding holographic weapon sight in accordance with the present invention;

FIG. 2 is a side view of the sight of FIG. 1 with the sight in an extended position; and

FIG. 3 is a side view of the sight of FIGS. 1 and 2 showing multiple alternative positions for the sight.

### DETAILED DESCRIPTION OF THE INVENTION

The present invention provides a holographic weapon sight that folds for storage or to position where a portion of the sight is out of the way when not in use. Certain embodiments include a readout beam source mounted to the stationary base of the sight and the source directly illuminates a hologram plate supported in a pivotally mounted hologram support when the sight is in a position intended for use.

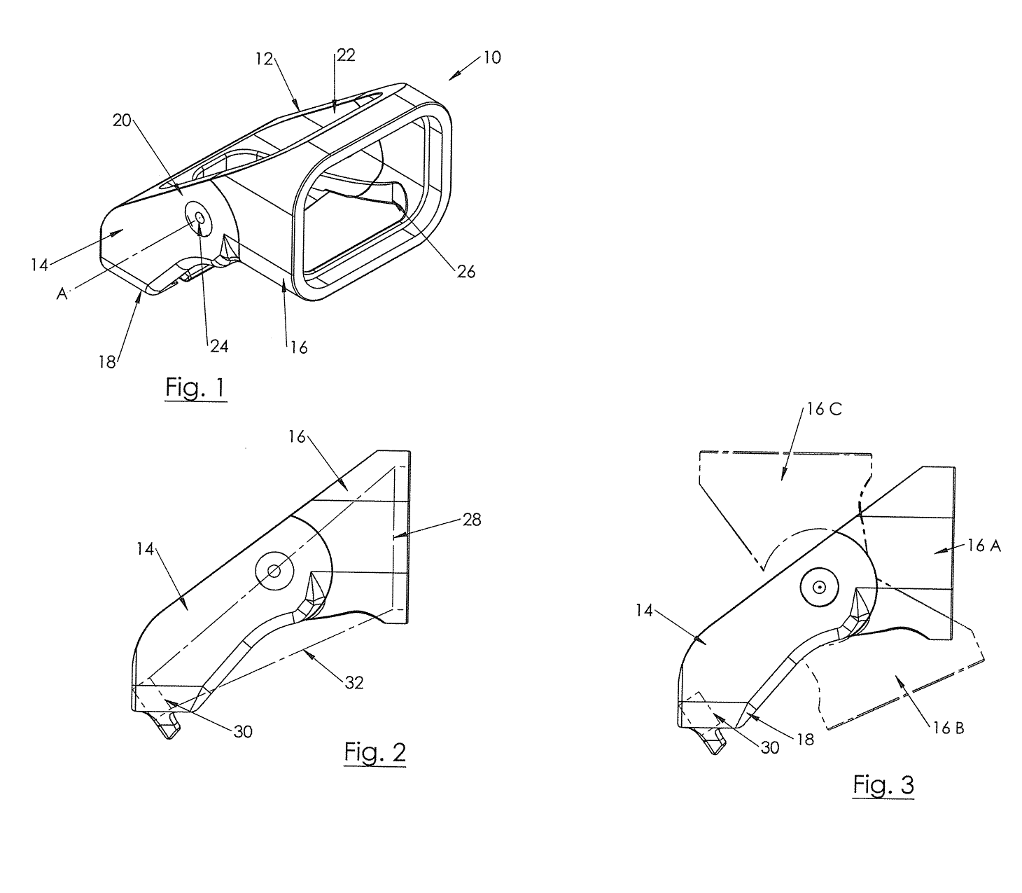

Referring to FIG. 1, a first embodiment of a folding holographic sight is shown at 10. The sight 10 includes a hologram mount 12 having a base 14 configured to mount to a weapon and a hologram support 16 that is pivotally attached to the base 14. The base 14 has a lower portion 18 that mounts to the weapon. It may be attached to a mounting device, may include any of a variety of mounting features and/or may directly attach to attachment features on the weapon. The mount may be considered a stationary portion of the hologram mount.

The base 14 further has an upper portion extending up from the base. In the illustrated embodiment, the upper portion takes the form of two arms 20 and 22 at opposed sides of the base 14. The hologram support 16 is pivotally attached to the arms 20 and 22 by pivots 24. The pivots define a generally horizontal pivot axis A. Alternatively, the hologram support may be attached to the base in other ways, including attachments other than a pivotal attachment, though it is preferred that the hologram support be movable between a folded and extended position.

The hologram support 16 defines an opening or window 26 and a hologram plate 28 is supported in the window 26. The hologram plate has a target image hologram recorded thereon. The target image may be a dot, a reticle, or any other image.

As known to those of skill in the art, a hologram plate is typically illuminated with coherent light in order to make the image recorded on the plate visible to a user. In the illustrated embodiment, a readout beam source is shown at 30 in FIG. 2. This readout beam source may be a laser diode or a vertical-cavity surface-emitting laser (VCSEL) light source. The source 30 emits a diverging beam of light 32 that illuminates the hologram plate 28 when the hologram plate is in the path of the beam. Unlike some holographic sights, the beam 32 comes directly from the source 30 to the plate without any other optical elements for providing the illumination. On some sights, a beam from a source illuminates a grating, which in turn illuminates the hologram plate or other intermediate optical or holographic optical elements. Further, some may include various lenses. In an alternative embodiment of the present invention, one or more lenses are provided between the source 30 and plate 28, but no holographic optical elements, such as gratings, are used. In yet a further alternative, holographic optical elements are included. However, the direct illumination approach illustrated in FIG. 2 is preferred for some embodiments.

In FIG. 2, the hologram support 16 is shown in an extended or use position wherein a user may use the sight 10 to aim the weapon by looking through the plate 28. Referring to FIG. 3, the hologram support is shown in several alternative positions. The hologram support is indicated in an alternative extended position at 16A. This position is angled slightly (5 degrees upwardly) with respect to the position in FIG. 2. The position at 16A may still be considered a use or extended position since a beam from the source 30 will illuminate the hologram plate. The hologram support is shown in a first folded position at 16B, with the support pivoted downwardly toward the lower portion 18 of the base 14. This folded position allows for more compact storage of the sight 10 and a weapon to which it is mounted. For example, this may allow the weapon to fit into a holster or case. The hologram support is shown in a second folded position at 16C, with the support pivoted upwardly. This position may also allow for storage. The support 16 may be continuously pivotable between the various positions and/or may have discrete detents for holding the support in particular positions.

In some versions, the readout beam source 30 is operable to illuminate the hologram plate 28 only when the hologram support is in a position in which the beam from the source will illuminate the plate 28 or only when the hologram support is in a predefined use position. A control may be provided for controlling the source 30, such as an on-off switch. Further, the source 30 may be a laser light source and control designed for providing a stable output wavelength, in accordance with the discussion in co-pending U.S. patent application Ser. No. 14/331,925, filed Jul. 15, 2014, which is incorporated herein in its entirety by reference.

A gun sight in accordance with the present invention may also incorporate the thermal control referred to herein as smart light control. Thermal stability of the-virtual image, or the observed position of the reconstructed reticle, is achieved by using a wavelength tunable source which may be a VCSEL. The need for stability is a consequence of the changes in ambient temperature. A VCSEL as a light source is used which is driven in such a way that its wavelength output will remain stable. The wavelength of the VCSEL is controlled by controlling the current it is given. The smart light control varies the amplitude of the laser current to correct for wavelength drift caused by temperature changes. Alternatively, the control system may be used to adjust the wavelength to a desired wavelength.

In some examples, a pulse width signal is used to energize the VCSEL. As such, the VCSEL is energized and on for an on-period and turns off for an off-period. This on/off cycling is very rapid such that the laser light produced by the VCSEL may appear as substantially constant to a human observer. Brightness is adjusted by varying the duty cycle. The duty cycle can be changed by (1) modulating the pulse width and/or (2) varying the pulse repition frequency (PRF).

In some versions, an open loop control system is used to control the VCSEL. In this example, the temperature of the VCSEL is monitored and then the current to the VCSEL is adjusted to a value based on the known or tested characteristics of the VCSEL. In some examples, the temperature of the VCSEL is determined by measuring the temperature using a thermocouple or other temperature sensing element in close proximity to the VCSEL. Any approach to temperature sensing may be used. In another approach, the VCSEL is “interrogated” with a low level bias current during the off-period of the duty cycle. As known to those of skill in the art, the voltage of the VCSEL will change with temperature. This allows the temperature of the VCSEL to be directly determined. This information is then used by the control system to adjust the current input during the subsequent on-periods of the cycle. Alternatively, the control may be a temperature control from another area, such as near the VCSEL.

In an alternative approach, a closed loop control system is used wherein a wavelength sensor measures the output wavelength of the VCSEL. This information may then be used by the control system to adjust the current to the VCSEL, allowing a desired output wavelength to be achieved. Example sensor systems are:
a) Passive dispersion (e.g. grating or prism) changes the beam angle a fixed amount based on laser wavelength with the sensor being one or more detectors
b) Interference filter (e.g Bragg notch filter, Fabry-Perot) outputs an optical signal that peaks at a center wavelength and is sensed by one detector.
c) Active dispersion (e.g. AOM and AOTF) changes the beam angle an adjustable amount based on laser wavelength with the sensor being one or more detectors
d) Interferometric (e.g. FTIR and Sagnac) produces wavelength dependent fringes in space or time and is sensed by one or more detectors.
e) Polarization (e.g. polarizer and analyzer) produces an output signal that peaks at a center wavelength.
f) Semiconductor-base wave meters analyze signal levels from two or more stacked detectors with different spectral responses.

Case (a) can also be implemented by integrating the wavelength grating into the hologram. For example, when the hologram was constructed a second object beam would be introduced, that when readout would illuminate the one or more detectors.

Cases (a) and (b) when a single detector is used, the controller will need to dither the laser wavelength to maintain the maximum signal. The dithering will also shift the reticle and must be limited to a narrow range; this effect can be avoided at the cost of two or more sensors. For cases (a) and (b) two or more sensors will produce two signals that can be adjusted to some desired levels and avoids dithering.

Case (c) uses dithering that is applied to a piezoelectric and produces a beam steering similar to case (a). This dither, however, doesn't affect the reticle position and can be sensed by any detector configuration.

Cases (d), (e), (f) would be operated in the conventional wavelength sensing modes.

The control system may use one or multiple inputs, such as information from a wavelength sensor, a temperature sensor, or other information.

In accordance with a further aspect of the present invention, a holographic sight is constructed including a VCSEL and a current control system as described above. Alternatively, any other wavelength stable light source may be used. Such a sight may reduce or eliminate the need for an achromatic system and may achieve higher levels of wavelength stability over an operating temperature range. In one example, the wavelength output of a VCSEL may change by approximately 2 nanometers over a 40° Celsius temperature range. The same VCSEL may have a current sensitivity such that a change in current will cause a 2 nanometer change in the wavelength, thereby allowing complete compensation for wavelength shift. Such a holographic sight may include an open loop or a closed loop control system as described above. In a further example, the control system may be used to adjust the position of a holographic image in the sight. For example, changes in wavelength may cause a change in the perceived vertical position of the holographic image in the sight. As such, the wavelength may be adjusted so as to compensate for elevation. For example, the current level may be changed so as to raise or lower the perceived position of the holographic image, depending on the design of the sight. As such, the present invention allows electronic adjustment of elevation in certain embodiments.

The gun sight of the present invention is compact and intended for use with a hand held weapon. Compact being defined as occupying little space compared with others of its type. Accordingly, the gun sight of the present invention is significantly smaller and occupies less space as compared to similar gun sights. Furthermore, “hand held” is defined as being for use with a refile, handgun, pistol . . . etc. or any other known weapon commonly used in a hand held manner. “Hand held” way also include weapons mounted to a tripod (or other mount) but small in nature (small compared to a vehicle or airplane). Hand held includes all other non-vehicle (i.e. a tank) weapons.

As will be clear to those of skill in the art, the invention described herein may be altered in various ways without departing from the scope or teaching of the present invention. As such, this application should be interpreted broadly.

The invention is not restricted to the illustrative examples and embodiments described above. The embodiments are not intended as limitations on the scope of the invention. Methods, apparatus, compositions, and the like described herein are exemplary and not intended as limitations on the scope of the invention. Changes therein and other uses will occur to those skilled in the art. The scope of the invention is defined by the scope of the claims.

1. A folding holographic gun sight, the folding holographic gun sight comprising:
a hologram mount having a base configured to mount to a gun and a hologram support, the hologram support pivotally attached to the base for movement between a folded position and an extended position;
a hologram plate supported in the hologram support, the hologram plate having a target image hologram recorded thereon; and
a readout beam source operable to emit a readout light beam;
the readout light beam adapted to illuminate the hologram plate when the hologram plate is in the extended position.

2. A folding holographic sight in accordance with claim 1, wherein:
the readout beam source is mounted to the base of the hologram mount.

3. A folding holographic sight in accordance with claim 1, wherein:
optical elements are absent between the readout beam source and the hologram plate.

4. A folding holographic sight in accordance with claim 1, wherein:
the readout beam source is a laser light source operable to generate a laser light readout beam.

5. A folding holographic sight in accordance with claim 1, wherein:
the readout beam source is a vertical-cavity surface-emitting laser (VCSEL) light source.

6. A folding holographic sight in accordance with claim 1, wherein:
the hologram support is continuously pivotable to a plurality of positions between the folded and extended positions.

7. A folding holographic sight in accordance with claim 1, wherein:
the hologram mount further includes detents for defining the folded and extended positions of the hologram support.

8. A folding holographic sight in accordance with claim 1, wherein:
the hologram support is further moveable to a second folded position

9. A folding holographic sight in accordance with claim 1, wherein:
the readout beam source is a laser light source and control, comprising:
a vertical-cavity surface-emitting laser (VCSEL) operable to emit a beam of light at an output wavelength when energized;
a power source for energizing the VCSEL with an injection current;
a control for controlling the injection current to the VCSEL; and
a temperature sensor for sensing a temperature of the VCSEL, the temperature sensor providing an input to the control;
wherein the control is operable to adjust the injection current to the VCSEL such that the output wavelength is approximately the same as a desired wavelength.

10. A folding holographic sight in accordance with claim 9, wherein:
the temperature sensor is a voltage sensor operable to measure the voltage of the VCSEL during an off-period of a duty cycle.

11. A folding holographic sight in accordance with claim 1, wherein:
the readout beam source is a laser light source and control, comprising:
a vertical-cavity surface-emitting laser (VCSEL) operable to emit a beam of light at an output wavelength when energized;
a power source for energizing the VCSEL with an injection current;
a control for controlling the injection current to the VCSEL;
a wavelength sensor for sensing a wavelength of the VCSEL, the wavelength sensor providing an input to the control;
wherein the control is operable to adjust the injection current to the VCSEL such that the output wavelength is approximately the same as a desired wavelength.

12. A folding holographic sight in accordance with claim 9 or 11, wherein:
the wavelength sensor is selected from a group of sensor systems consisting of:
a passive dispersion (e.g. grating or prism) sensor system wherein a beam angle changes a fixed amount based on laser wavelength and the system includes one or more detectors for detecting beam angle changes;
an interference filter (e.g Bragg notch filter, Fabry-Perot) system operable to output an optical signal that peaks at a center wavelength and the system includes a sensor for sensing the optical signal;
an active dispersion (e.g. AOM and AOTF) sensor system wherein a beam angle changes by an adjustable amount based on laser wavelength and the system includes one or more detectors for detecting bean angle changes;
an interferometric (e.g. FTIR and Sagnac) sensor system operable to produce wavelength dependent fringes in space or time and the system includes one or more detectors for sensing the wavelength dependent fringes;
a polarization (e.g. polarizer and analyzer) based sensor system operable to produce an output signal that peaks at a center wavelength; and
a semiconductor-base wave meter operable to analyze signal levels from two stacked detectors with different spectral responses.

13. A folding holographic sight for a weapon, comprising:
a hologram mount having a base configured to mount to a weapon and a hologram support, the hologram support movably attached to the base for movement between a folded position and an extended position;
a hologram plate supported in the hologram support, the hologram plate having a target image hologram recorded thereon; and
a readout beam source operable to emit a readout light beam;
the readout light beam adapted to illuminate the hologram plate when the hologram plate is in the extended position.
